(19) United States
(12) Patent Application Publication
(10) Pub. No.: US 2017/0150849 A1
(43) Pub. Date: Jun. 1, 2017

(54) FOOD PREPARATION IMPLEMENT

(71) Applicant: Jo-Anne Simard, Terrebonne (CA)

(72) Inventor: Jo-Anne Simard, Terrebonne (CA)

(21) Appl. No.: 14/955,312

(22) Filed: Dec. 1, 2015

(51) Int. Cl. A47J 43/26; A47J 19/00

(52) U.S. Cl. CPC A47J 43/26; A47J 19/005

(57) ABSTRACT

A food preparation implement usable by an intended user for pressing and crushing foodstuff, the intended user having a hand, the food preparation implement comprising: a first jaw and a second jaw, the first and second jaws being pivotally attached to each other at a pivot location so as to be movable between an open configuration and a closed configuration; the first jaw including a pressing compartment, the pressing compartment being defined by a pressing wall and a peripheral wall extending therefrom, the pressing wall defining a pressing aperture extending therethrough, the second jaw including a plunger, the plunger being insertable into the pressing compartment when the first and second jaws are in the closed configuration; the first and second jaws also including respectively a first and a second jaw crushing wall, the first and second jaw crushing walls being located substantially opposed to each other and substantially adjacent to each other when the first and second jaws are in the closed configuration.

### FIELD OF THE INVENTION

The present invention relates to the general field cooking and is more particularly concerned with a food preparation implement.

### BACKGROUND OF THE INVENTION

Cooking often requires that different foods be processed differently. For example, there might be a need to crush garlic when cooking a dish and to, afterwards, crush the shell of nuts to extract the edible portion of the nut. Also, there might be a need to press food through openings having different shapes and sizes to produce differently shaped and sized pieces of food.

Typically, all these operations are performed using different utensils. Therefore, users of such utensils need to buy and store a relatively large number of utensils, which is relatively expensive and increases the time required to retrieve these utensils for use, wash them after use and store them after a dish has been cooked.

Furthermore, nutcrackers typically have a relatively simple design and include simply two relatively rectilinear levers between which a nut is inserted for crushing of its shell. This requires that the nut be stabilized by the hand of an intended user while the other hand operates the nutcracker. Since there is a risk that the nut may slip from between the two levers, there is risk that the intended user may injure himself as his hand may become stuck between the two levers if they get close to each other rapidly due to the sudden decrease in resistance to this motion caused by the slipping nut. Also, when the nut has a relatively smooth surface, the intended user may take a relatively long time to crack the nut as the nut needs to be repeatedly repositioned between the two levers before a successful crushing of the shell occurs.

Many inventors have tried to alleviate at least in part the above-mentioned disadvantages. For example, U.S. Patent Application No. 2003/022162 published Dec. 4, 2003 and filed by Klamer describes a garlic crusher including two inserts having different shapes. However, the inserts described in this document are relatively large and therefore require that a relatively large device be used for their storage.

U.S. Pat. No. 5,520,104 issued on May 28, 1996 by Ancona et al. illustrates a food preparation utensil in which two compartments are usable to either press foodstuff through relatively small round apertures or slice foodstuff by pressing the foodstuff through a grate including substantially parallel slits. However, this food preparation utensil includes two different compartments, each compartment being dedicated to one of these two uses. Therefore, this food preparation utensil is relatively large and does not provide flexibility as the types of apertures through which food is pushed are fixed.

Accordingly, there exists a need for an improved food preparation implement. It is a general object of the present invention to provide such a food preparation implement.

### SUMMARY OF THE INVENTION

In a first broad aspect, the invention provides a food preparation implement usable by an intended user for pressing and crushing foodstuff, the intended user having a hand, the food preparation implement comprising:
a first jaw and a second jaw, the first and second jaws being pivotally attached to each other at a pivot location so as to be movable between an open configuration and a closed configuration;
the first jaw including a pressing compartment, the pressing compartment being defined by a pressing wall and a peripheral wall extending therefrom, the pressing wall defining a pressing aperture extending therethrough, the second jaw including a plunger, the plunger being insertable into the pressing compartment when the first and second jaws are in the closed configuration;
the first and second jaws also including respectively a first and a second jaw crushing wall, the first and second jaw crushing walls being located substantially opposed to each other and substantially adjacent to each other when the first and second jaws are in the closed configuration;
whereby, in use, pressing the foodstuff towards the pressing wall using the plunger allows pressing the foodstuff through the pressing aperture, and exerting a force moving the first and second crushing walls towards each other with the foodstuff positioned therebetween allows crushing the foodstuff.

Advantageously, the proposed food preparation implement is able to perform many functions, such as pressing foodstuff and crushing foodstuff while remaining relatively small and compact. Therefore, the proposed food preparation implement may be manufactured using a relatively small quantity of material, which typically leads to a relatively low manufacturing cost.

Furthermore, the proposed food preparation implement allows an intended user to have a relatively well-equipped kitchen using only a relatively small number of utensils as the proposed food preparation implement provides a functionality provided typically by many utensils.

The proposed food preparation implement is furthermore flexible as, in some embodiments, it includes many inserts that may be used as the pressing wall, the inserts having differently sized and configured apertures. Therefore, many different operations may be performed using this single food preparation implement.

In some embodiments of the invention, at least one of the first and second crushing walls has a substantially concave configuration. This configuration therefore helps in stabilizing convex foodstuff such as, for example, nuts, that needs to be crushed by the crushing walls.

The proposed food preparation implement is relatively ergonomic to use and relatively easily cleaned. This ease of cleaning if further enhanced by inclusion, in some embodiments of the invention, of a cleaning element that is storable into the food preparation implement and usable to clean the inserts.

Yet, furthermore, having inserts that are removable from the food preparation implement increases the ease of cleaning the food preparation implement as the inserts may be relatively easily washed separately from the remaining parts of the food preparation implement. Therefore, cleaning of the food preparation implement and, more specifically, of relatively small apertures in the inserts, is not hindered by the configuration and shape of the food preparation implement.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

An embodiment of the present invention will now be disclosed, by way of example, in reference to the following drawings, in which:

FIG. 1, in a perspective view, illustrates a food preparation implement in accordance with an embodiment of the present invention, the food preparation implement being shown in a closed configuration;

FIG. 2, in a perspective exploded view, illustrates the food preparation implement shown in FIG. 1;

FIG. 3, in a top plan view, illustrates the food preparation implement shown in FIGS. 1 and 2;

FIG. 4, in a side elevation view, illustrates the food preparation implement shown in FIGS. 1 to 3;

FIG. 5, in a front elevation view, illustrates the food preparation implement shown in FIGS. 1 to 4;

FIG. 6, in a side elevation view, illustrates the food preparation implement shown in FIGS. 1 to 5, the food preparation implement being shown in an opened configuration; and

FIGS. 7 to 10, in top elevation views, illustrate inserts usable in the food preparation implement shown in FIGS. 1 to 6.

### DETAILED DESCRIPTION

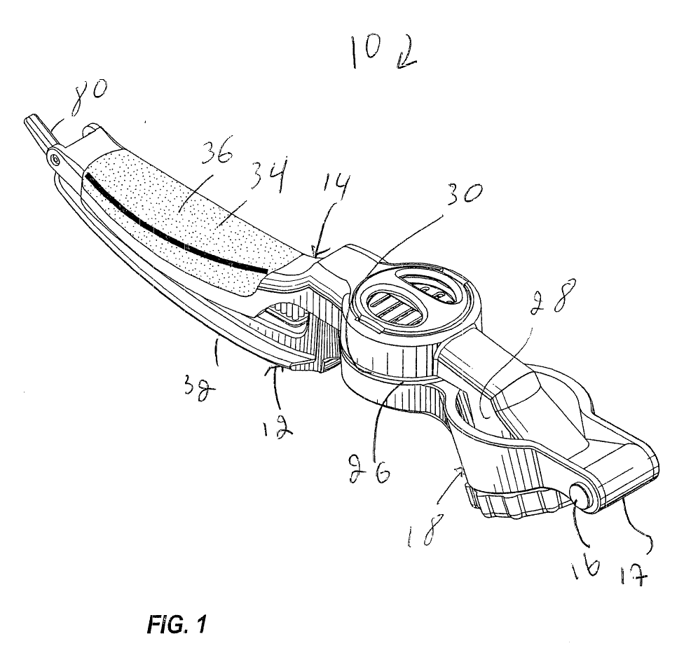

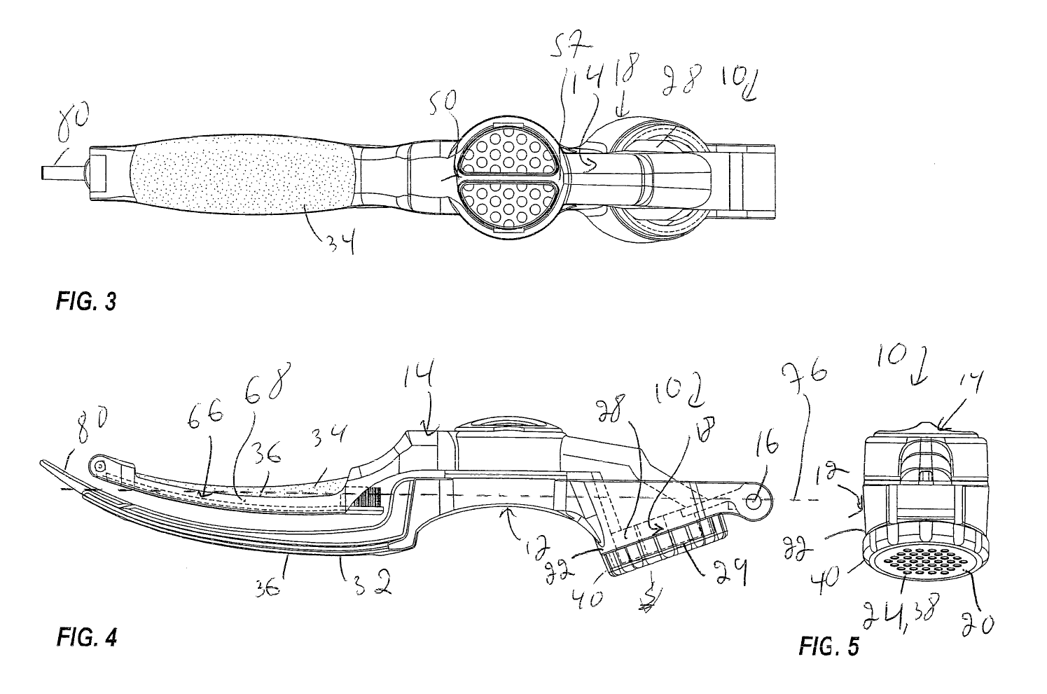

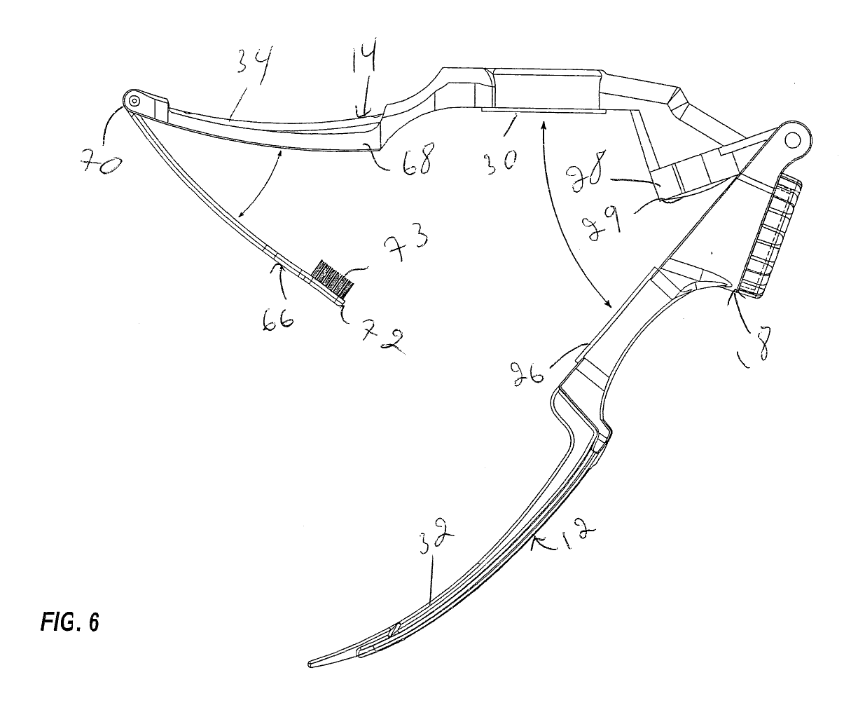

FIGS. 1 to 6 illustrate a food preparation implement 10 usable by an intended user having a hand for pressing and crushing foodstuff (not shown in the drawings). The food preparation implement includes a first jaw 12 and a second jaw 14. The first and second jaws 12 and 14 are pivotally attached to each other at a pivot location 16 so as to be movable between an opened configuration shown, for example, in FIG. 6 and a closed configuration shown, for example, in FIG. 1. In some embodiments of the invention, the first and second jaws 12 and 14 are attached to each other through a hinge 17.

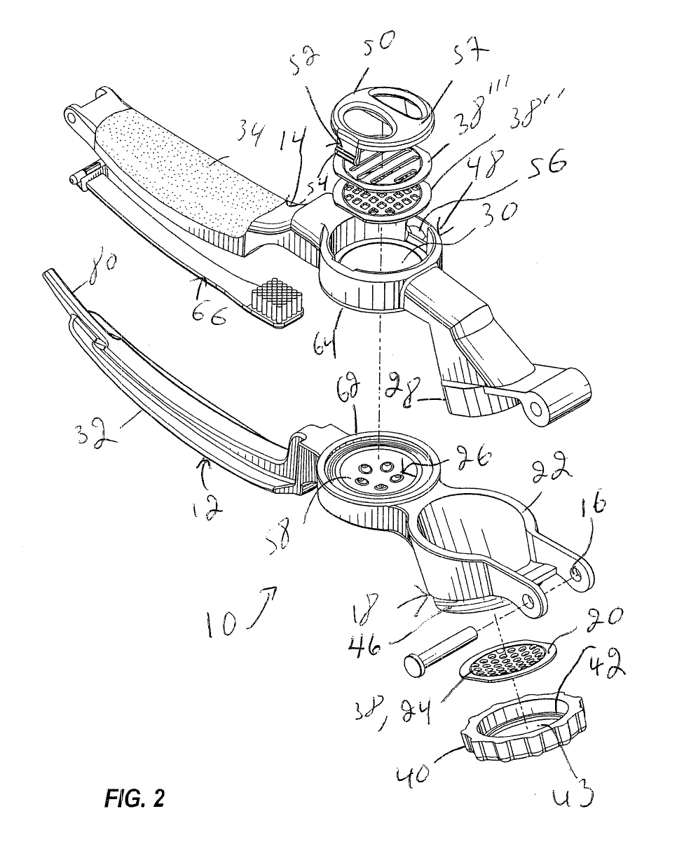

As seen for example in FIG. 2, the first jaw 12 includes a pressing compartment 18. The pressing compartment 18 is defined by a pressing wall 20 and a peripheral wall 22 extending therefrom. The pressing wall 20 defines at least one, and typically a plurality of, crushing aperture 24 extending therethrough. The second jaw 14 includes a plunger 28. The plunger 28 is insertable into the pressing compartment 18 when the first and second jaws are in the closed configuration, as illustrated in FIG. 4, and, in some embodiments of the invention, has a periphery having a shape and a size substantially similar to the size and shape of the internal surface of at least a portion of the pressing wall 20.

Referring to FIG. 2, the first and second jaws 12 and 14 also include, respectively, a first and a second jaw crushing walls 26 and 30. The first and second jaw crushing walls 26 and 30 are located substantially opposed to each other and substantially adjacent to each other when the first and second jaws 12 and 14 are in the closed configuration.

In use, pressing the foodstuff towards the pressing wall 20 using the plunger 28 allows pressing the foodstuff through the pressing aperture 24, and exerting a force moving the first and second crushing walls 26 and 30 towards each other with the foodstuff positioned therebetween allows crushing the foodstuff. Therefore, the food preparation implement is usable both for crushing foodstuff and for pressing foodstuff using a single compact and relatively easily usable food preparation implement.

As seen in FIG. 4, in some embodiments of the invention, the plunger 28 defines a plunger end wall 29 that is substantially adjacent or abuts against the pressing wall 20 when the food preparation implement 10 is in the closed configuration. This configuration allows pressing most of or all the foodstuff located within the pressing compartment 18 through the pressing aperture 24.

In some embodiments of the invention, both the pressing compartment 18 and the first and second crushing walls 26 and 30 have a substantially cylindrical configuration. This configuration allows providing a relatively compact food preparation implement, while manufacturing the food preparation implement distributes relatively evenly the material when the food preparation implement 10 is molded, which reduces stress concentration and facilitates therefore molding of the food preparation implement 10.

As seen in FIG. 1, for example, the pressing compartment 18 is closer to the pivot location 16 than the first jaw crushing wall 26. This configuration is advantageous as it allows the exertion of a relatively large force onto the foodstuff that is to be pressed using the plunger 28 because of the relatively large leverage provided by the food preparation implement 10, while allowing the food preparation implement 10 to be used relatively easily to crush foodstuff between the first and second jaw pressing walls 26 and 30. Indeed, crushing foodstuff typically requires a relatively large force and is typically performed by pressing the first and second jaws 12 and 14 towards each other using a single hand. To be able to accommodate relatively large foodstuff to crush, there is a need to locate the first and second jaw crushing walls 26 and 30 at a location spaced-apart from the pivot location 16, as providing these crushing walls too close to the pivot location 16 would result in the first and second jaws 12 and 14 being spaced apart by too large a distance when the foodstuff is inserted therebetween before being crushed. One-handed operation of the food preparation implement 10 is also advantageous as it allows the intended user to locate his other hand substantially adjacent the first and second jaw crushing walls 26 and 30 to recover fragments of the crushed foodstuff.

Referring for example to FIG. 1, in some embodiments of the invention, the first and second jaws 12 and 14 include respectively first and second jaw handles 32 and 34 for receiving the hand of the intended user. The pressing compartment 18, the plunger 28, and the first and second jaw crushing walls 26 and 30 are located between the first and second jaw handles 32 and 34 and the pivot location 16. This configuration allows exerting relatively large forces using the first and second jaw crushing walls 26 and 30 and using the plunger 28 while keeping a relatively compact configuration. In some embodiments of the invention, the first and second jaw handles 32 and 34 each define a gripping surface 36 for allowing the intended user to position his hand onto the gripping surface 36 with relatively small risks of the hand slipping. The gripping surface 36 includes typically a relatively sticky polymer having a relatively large friction coefficient with human skin.

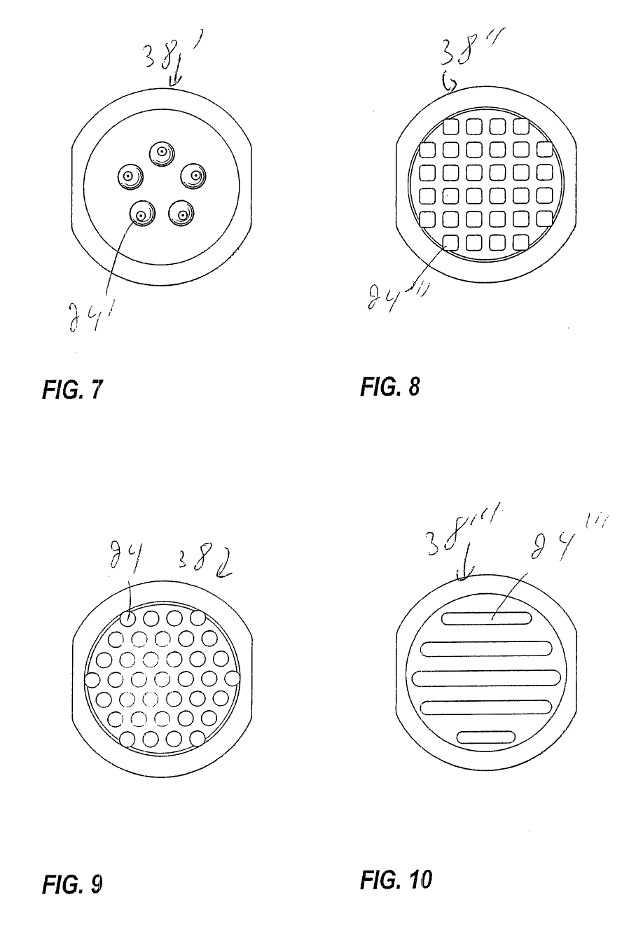

In some embodiments of the invention, the pressing wall 20 is removably attachable to the remaining parts of the food preparation implement 10. In these embodiments, the pressing wall 10 includes an insert 38, 38′, 38″, 38′″. The insert 38, 38′, 38″, 38′″ is removably attachable to the first jaw 12. FIGS. 7 to 10 illustrate respectively various examples of inserts 38′, 38″, 38 and 38′″ that may be usable with the food preparation implement 10, the inserts 38′, 38″, 38 and 38′″ having respectively pressing apertures 24′, 24″, 24 and 24′″ having various sizes, shapes and configurations. Typically, inserts having relatively small pressing apertures allow pressing foodstuff therethrough, while inserts defining slits allow to either press relatively hard foodstuff therethrough or to cut relatively soft foodstuff by pressing the foodstuff through these slits.

As better seen in FIG. 2, the inserts 38, 38′, 38″, 38′″ are attachable to the first jaw 12 using an attachment collar 40. The attachment collar 40 is removably attachable to the first jaw 12. The attachment collar 40 defines an abutment surface 42, the insert 38, 38′, 38″, 38′″ being positioned between the abutment surface 42 and the first jaw 12 when the insert 38, 38′, 38″, 38′″ is attached to the first jaw 12. The abutment surface 42 has a substantially annular shape and, therefore, defines a collar aperture 43 extending radially inwardly therefrom for allowing discharge of the foodstuff from the food preparation implement 10 after it has been pressed through the pressing wall 20.

In some embodiments of the invention, the inserts 38 are substantially disc-shaped and the attachment collar 40 is therefore substantially cylindrical. In this embodiment, the attachment collar 40 may define collar threads 44 and the peripheral wall 22 may define peripheral wall threads 46. The collar 40 is screwable to the peripheral wall 20 by engaging the peripheral wall threads 46 with the collar threads 44 and rotating the attachment collar 40 relatively to the peripheral wall 22.

As seen better in FIG. 2, in some embodiments of the invention, the second jaw 14 defines a storage compartment 48 for storing at least one of the inserts 38, 38′, 38″, 38′″ when the inserts 38, 38′, 38″, 38′″ are not used. For example, the storage compartment 48 is located substantially in register with the second jaw crushing wall 30. This configuration allows manufacturing a relatively compact food preparation implement 10 that is nevertheless relatively sturdy as the storage compartment, having a relatively large dimension, reinforces the food preparation implement 10 adjacent the second crushing wall 30. In some embodiments of the invention, the storage compartment 48 extends from the second jaw crushing wall 30.

Access to the storage compartment 48 is provided through a storage compartment cover 50 that is removably attachable to the storage compartment 48. Removal of the storage compartment cover 40 allows to slide the inserts 38, 38′ and 38″ into the storage compartment 48 and positioning of the storage compartment cover 50 over the storage compartment 48 prevents the inserts from being dislodged from the storage compartment 48.

In some embodiments of the invention, the storage compartment cover 50 has a substantially disc-shaped configuration and includes a cover wall 57. Tongues 52 extend substantially perpendicularly from the cover wall 57 and end into protrusions 54. Protrusions 54 are located so as to be able to engage recesses 56 provided in the peripheral wall of the storage compartment 48. The tongues 52 are substantially resiliently deformable so as to be pressed towards each other when the storage compartment cover 50 is inserted towards the storage compartment 48 and to thereafter revert to their original configuration so as to engage the recesses 56.

At least one of the first and second jaw crushing walls 26 and 30 defines a substantially concave crushing surface 58, only one of which is seen in FIG. 2, for receiving the foodstuff. In some embodiments of the invention such as, for example, in the embodiment shown in FIG. 2, both the first and second jaw crushing walls 26 and 30 define a respective crushing surface 58. The crushing surfaces 58 each have a substantially concave configuration and allow to receive the foodstuff therebetween so that the intended user may exert a crushing force thereonto while maintaining relatively stably the foodstuff to crush between the crushing surfaces 58.

The first and second jaw crushing walls 26 and 30 define respectively a first wall peripheral edge 62 and a second wall peripheral edge 64. In some embodiments of the invention, the first and second wall peripheral edges 62 and 64 abut against each other when the first and second jaws are in the closed configuration. Therefore, the first and second jaw crushing walls 26 and 30 may come close to each other or even abut against each other in the closed configuration, so as to allow crushing of relatively small pieces of foodstuff.

In some embodiments of the invention, as seen for example in FIG. 6, the food preparation implement 10 includes a cleaning element 66 for cleaning the pressing apertures 24 and dislodging the foodstuff therefrom. At least one of the first and second jaws 12 and 14 defines a cleaning element receiving compartment 68, the cleaning element 68 being removably insertable into the cleaning element receiving compartment 68. In the embodiment of the invention shown in the drawings, the second jaw 14 defines the cleaning element storage compartment 68. Also, the cleaning element 66 is pivotally attached to the second jaw 14. However, in alternative embodiments of the invention, the cleaning element 66 is attached in any suitable manner to either one of the first and second jaws 12 and 14.

More specifically, the cleaning element 66 defines a cleaning element first end 70 and a cleaning element second end 72. The cleaning element 66 is pivotally attached to the second jaw 14 substantially adjacent the proximal end thereof at a location substantially adjacent the cleaning element first end 70. The cleaning element 66 is therefore movable between a retracted configuration, seen for example in FIG. 4, and an extended configuration, seen for example in FIG. 6. The cleaning element 66 is inserted into the cleaning element receiving compartment 68 when the cleaning element is in the retracted configuration. In the extended configuration, the cleaning element 66 is usable for cleaning the inserts 38. For example, the cleaning element 66 defines a brush 73 substantially adjacent the cleaning element second end 72. Having the cleaning element 66 attached to one of the first and second jaws 12 and 14 reduces risks of losing, dropping or misplacing the cleaning element 66.

Referring to FIG. 4, in some embodiments of the invention, in the closed configuration, the first and second jaws 12 and 14 are substantially parallel to each other and define a longitudinal axis 76. The pressing wall 20 is acutely angled relative to the longitudinal axis 76 in a plane extending across the first and second jaws when the first and second jaws are in the opened configuration. In other words, the pressing wall 20 is angled relatively to the remaining portions of the first and second jaws 12 and 14, which facilitates operation of the food preparation implement. Indeed, foodstuff is typically pressed by an intended user over a counter top, which is typically located below the hands of the intended user. Therefore, this acute angle allows holding the food preparation implement 10 at an ergonomic angle while allowing the foodstuff to be pressed out of the food preparation implement 10 relatively perpendicularly to the surface towards which it is pressed. This therefore facilitates the use of the food preparation implement 10 as the foodstuff may then fall into a suitable container or onto a suitable food receiving surface relatively easily.

In some embodiments of the invention, the food preparation implement 10 includes a point 80 extending substantially longitudinally from one of the first and second jaws 12 and 14 at a location substantially opposed to the pivot location 16. The point 80 may be used, for example, to pierce foodstuff to insert other foodstuff thereinto such as, for example, piercing a hole through meat to insert garlic pieces.

In the embodiment of the invention shown in the drawings, the point 80 extends from the first jaw 12. The position of the point 80 onto the food preparation implement 10 reduces the risks of the intended user of becoming injured thereby when operating the food preparation implement.

Although the present invention has been described hereinabove by way of preferred embodiments thereof, it can be modified, without departing from the spirit and nature of the subject invention as defined in the appended claims.

What is claimed is:

1. A food preparation implement usable by an intended user for pressing and crushing foodstuff, said intended user having a hand, said food preparation implement comprising:
a first jaw and a second jaw, said first and second jaws being pivotally attached to each other at a pivot location so as to be movable between an open configuration and a closed configuration;
said first jaw including a pressing compartment, said pressing compartment being defined by a pressing wall and a peripheral wall extending therefrom, said pressing wall defining a pressing aperture extending therethrough, said second jaw including a plunger, said plunger being insertable into said pressing compartment when said first and second jaws are in said closed configuration;
said first and second jaws also including respectively a first and a second jaw crushing wall, said first and second jaw crushing walls being located substantially opposed to each other and substantially adjacent to each other when said first and second jaws are in said closed configuration;
whereby, in use, pressing said foodstuff towards said pressing wall using said plunger allows pressing said foodstuff through said pressing aperture, and exerting a force moving said first and second crushing walls towards each other with said foodstuff positioned therebetween allows crushing said foodstuff.

2. A food preparation implement as defined in claim 1, wherein said pressing compartment is closer to said pivot location than said first jaw crushing wall.

3. A food preparation implement as defined in claim 2, wherein said first and second jaws include respectively first and second jaw handles for receiving said hand, said pressing compartment and said first jaw crushing wall being located between said pivot location and said first jaw handle, said plunger and said second jaw crushing wall being located between said pivot location and said second jaw handle.

4. A food preparation implement as defined in claim 1, wherein said pressing wall includes an insert, said insert being removably attachable to said first jaw.

5. A food preparation implement as defined in claim 4, further comprising an attachment collar, said attachment collar being removably attachable to said first jaw, said attachment collar defining an abutment surface, said insert being positioned between said abutment surface and said first jaw when said insert is attached to said first jaw.

6. A food preparation implement as defined in claim 5, wherein said insert is substantially disc-shaped.

7. A food preparation implement as defined in claim 5, wherein
said attachment collar defines collar threads; and
said peripheral wall defines peripheral wall threads, said attachment collar being screwable to said peripheral wall by engaging said peripheral wall threads with said collar threads and rotating said attachment collar relatively to said peripheral wall.

8. A food preparation implement as defined in claim 4, said food preparation implement comprising at least two inserts, each of said at least two inserts defining at least one respective pressing aperture extending therethrough.

9. A food preparation implement as defined in claim 8, wherein said second jaw defines a storage compartment for storing at least one of said at least two inserts.

10. A food preparation implement as defined in claim 9, wherein said storage compartment is located substantially in register with said second jaw crushing wall.

11. A food preparation implement as defined in claim 9, wherein said storage compartment extends from said second jaw crushing wall.

12. A food preparation implement as defined in claim 1, wherein at least one of said first and second jaw crushing walls defines a crushing surface for receiving said foodstuff and allowing said intended user to exert a crushing force thereonto, said crushing surface having a substantially concave configuration.

13. A food preparation implement as defined in claim 12, wherein said first and second jaw crushing walls define respectively a first wall peripheral edge and a second wall peripheral edge, said first and second wall peripheral edges abutting against each other when said first and second jaws are in said closed configuration.

14. A food preparation implement as defined in claim 1, further comprising a cleaning element for cleaning said pressing aperture and dislodging said foodstuff therefrom, at least one of said first and second jaws defining a cleaning element receiving compartment, said cleaning element being removably insertable into said cleaning element receiving compartment.

15. A food preparation implement as defined in claim 14, wherein said cleaning element is pivotally attached to one of said first and second jaws so as to be movable between a retracted configuration and an extended configuration, said cleaning element being inserted into said cleaning element receiving compartment when said cleaning element is in said retracted configuration.

16. A food preparation implement as defined in claim 15, wherein, in said retracted configuration, said cleaning element is located between said first and second jaws.

17. A food preparation implement as defined in claim 1, wherein, in said closed configuration, said first and second jaws are substantially parallel to each other and define a longitudinal axis.

18. A food preparation implement as defined in claim 17, wherein said pressing wall is acutely angled relatively to said longitudinal axis in a plane extending across said first and second jaws when said first and second jaws are in said open configuration.

19. A food preparation implement as defined in claim 1, wherein at least one of said first and second jaws defines a point located opposed to said pivot location, said point extending substantially longitudinally from said at least one of said first and second jaws.
